(19) United States
(12) Patent Application Publication
(10) Pub. No.: US 2009/0210334 A1
(43) Pub. Date: Aug. 20, 2009

(54) SYSTEM AND METHOD FOR PUBLICIZING BUSINESS SERVICES

(76) Inventor: Charles Mark RUSSELL, Roswell, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/033,783

(22) Filed: Feb. 19, 2008

(51) Int. Cl. G06Q 99/00

(52) U.S. Cl. 705/35; 705/1

(57) ABSTRACT

A system and method for publicizing business services including objective information for use by customers or prospective customers in selecting a service provider, including verified recordings of actual interactions between service providers and their customers. Additional subjective information, rating, comment, or the like may be provided to supplement the objective information, wherein the objective information may allow a user to put the subjective information into context.

### TECHNICAL FIELD

The present invention relates generally to business methods and computer systems, and, more particularly, to systems and methods for publicizing and evaluating business services.

### BACKGROUND OF THE INVENTION

Many businesses, especially new and/or small businesses, rely heavily on referrals from satisfied existing clients or customers in order to acquire new clients or customers. Typically, such referrals are made based on the prior experiences of the existing customer via anecdotal description and/or other recommendation. Conversely, unhappy or dissatisfied existing customers may discourage others from becoming a client or customer based on prior experience as recited by the existing client or customer. Numerous systems have been developed around dissemination of such prior experiential information communicated via anecdotal form or distilled to a simple rating, whereby prospective customers seeking a selected good or service may obtain information for use in selecting a provider. Unfortunately, however, such prospective customers have little or no ability to judge the veracity, accuracy, or appropriateness of another individual's anecdote, opinion, or rating of a given provider. This problem is exacerbated where the anecdote, opinion, or rating is provided via a computer network-based system and the prospective customer: 1) has no prior acquaintance with the individual providing the anecdote, opinion, or rating, 2) has no option to ask questions or gain other information to expose any bias that may affect the anecdote, opinion or rating, and 3) has no access to verified objective evidence of service quality.

For example, a given provider's conduct or service may be acceptable to a first customer, whereafter the first customer may provide a positive opinion and/or a high rating of the provider, but such conduct or service may be unacceptable to a second customer. If the second customer relies solely on the opinion and/or rating of the first customer, the second customer may become a customer of the provider, only to ultimately be disappointed. Likewise, the converse situation may occur, wherein an extremely sensitive customer may denounce a provider for a product or a service that is acceptable for the majority of customers. Nonetheless, customers may be turned away by a negative opinion or low rating provided by the disgruntled, overly-sensitive customer.

Furthermore, currently available systems and methods for providing prospective customers with experiential opinions and/or ratings allow for manipulation by unscrupulous providers. Specifically, providers may artificially inflate their own rating by submitting numerous positive reviews for themselves through dummy accounts. Additionally, such unscrupulous providers may attempt to artificially reduce the ratings of their competitors via negative reviews of the competitors. Thus, the benefit to prospective customers is reduced due to an inability or hesitance to rely on the reviews and/or due to reliance on biased reviews provided by unscrupulous providers or their agents. Additionally, providers of goods and services may have less incentive to aggressively pursue genuine customer satisfaction because of the ability to mask dissatisfied customers, whereby overall lower levels of service may be provided across an industry or market segment.

The value of an anecdote, opinion, rating, or other subjective information may also be affected by simple misunderstandings. For example, after a conversation between a service provider and a customer, one or both parties may be confused about what the other said. Such confusion often leads to unnecessary dissatisfaction with the relationship. Accordingly, inappropriate or undeserved negative opinions or ratings of the service provider may result.

Thus, it is clear that there is an unmet need for a system and method for publicizing business services that provides accurate, unbiased, and verifiable information to users seeking to locate reputable or recommended providers, that reduces inaccurate reviews or opinions based on confusion, that allows users to increase or decrease reliance on a selected review, including any anecdotal information, opinion, or rating, based on such unbiased and verifiable information, and that provides an incentive for goods and service providers to strive for excellence in customer service.

### BRIEF SUMMARY OF THE INVENTION

Briefly described, in a preferred embodiment, the present invention overcomes the above-mentioned disadvantages and meets the recognized need for such a system and method by providing a computer network-based system and method for publicizing business services including a computer program product operable to allow users to search for and locate one or more goods and services provider(s) and operable to provide access to feedback from one or more verified customer(s) of a selected goods and services provider, including recorded customer service interactions between the verified customer(s) and a representative of the selected provider.

More specifically, the computer program product provides access to a database of provider information and a search tool accessible by users operable to allow users to locate one or more provider. The computer program product may include an Internet-based phone book or the like to facilitate easy, efficient, and effective location of providers. The search tool may provide users with reviews, anecdotes, opinions, ratings, and/or the like, associated with a selected provider. Additionally, the search tool is operable to provide users with access to one or more previously-recorded audio, video, and/or text interaction(s) between the selected provider and a verified customer of the selected provider. Users may then base a decision regarding whether to become a customer of the selected provider on an opinion formed at least in part from one or more previously-recorded, authentic communication(s), taking into account their own preferences, whereby quality of provider selection may be improved.

The previously-recorded interaction(s) may be limited to only those interactions conducted through the system, whereby the validity of the interactions may be ensured. Thus, the computer program product preferably further provides a communication feature operable to allow registered users to initiate a recorded interaction with a selected provider. For example, and as discussed in greater detail below, a prospective customer may initiate a recorded interaction with a service provider in order document statements and assertions made by the service provider regarding future service. Alternatively, an existing customer may initiate a recorded interaction with a selected service provider to document the provider's response or reaction to complaints, questions, or the like. Completed recordings of an interaction between a customer and a provider are automatically stored and associated with the account of the user who initiated the recorded interaction. The user may subsequently publish the recording, included in redacted form to ensure user privacy. Such publication may be made by making the recorded interaction accessible via one or more of a listing associated with the provider in the directory, a review or feedback page associated with the service provider, a blog-style discussion or posting forum, a page associated with the user's account, or the like.

Accordingly, one feature and advantage of the present invention is its ability to enable convenient recording, storage, and publication of interactions between providers and their customers for provider accountability and for use by prospective customers in provider selection.

Another feature and advantage of the present invention is its ability to motivate providers to deliver high-quality service to each and every customer, and to motivate providers to avoid embarrassing, unacceptable, or inappropriate service, thereby improving the overall level of customer service offered to customers.

Yet another feature of and advantage of the present invention is its ability to avoid confusion regarding the content of interactions between customers and service providers by enabling review of recorded interactions.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawings, viewed in conjunction with the Detailed Description of the Invention referring thereto, in which like reference numbers throughout the various drawings designate like structure, and in which:

FIG. 1 is a diagram of a system for publicizing business services according to an embodiment of the present invention;

FIG. 2 is an illustration of an interface for account creation of the system of FIG. 1;

FIG. 3 is an illustration of a directory interface of the system of FIG. 1;

FIG. 4 is an illustration of an interface for publicizing an associated entity offering business services of the system of FIG. 1;

FIG. 5 is an illustration of an interface for managing an account of the system of FIG. 1;

FIG. 6 is an illustration of an interface of the system of FIG. 1 for editing content associated with an account;

FIG. 7 is an illustration of an interface for publicizing a plurality of entities offering business services of the system of FIG. 1; and

FIG. 8 is an illustration of an interface for publicizing business services of an associated user of the system of FIG. 1.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

In that form of the preferred embodiment of the present invention chosen for purposes of illustration, FIG. 1 shows system 100 including users 111-116, respectively associated user interface devices 121-126, and host 130, all connected via network 140. As will be understood by those ordinarily skilled in the art, each of users 111-116 may be a service provider and/or a customer of business services, and may or may not have previously registered or created an account. As used herein, the term “business service”, in plural or singular form, is intended to be broadly construed, including all or substantially all actions and/or conduct of a business, whether a corporation, sole proprietorship, partnership, or other entity. For example, traditional services such as healthcare services, lawn care services, repair services, legal services, and the like, without limitation, are encompassed by the term business services. Additionally, tangential services are likewise intended to be encompassed by the term business services. Thus, delivery of goods sold, manufacture of goods sold, provision of warranties for goods or services sold, customer support and interaction, billing assistance, solicitation, and the like, all constitute conduct and/or activity considered to be business services for the purpose of the instant description. Furthermore, as used herein, the term “customer” is intended to include any user, or potential user, whether for fee or for free, of any business services.

Each of user interface devices 121-126 preferably allows a respective associated one of users 111-116 to access host 130 and/or other devices connected, directly or indirectly, to network 140. Accordingly, each of user interface devices 121-126 may be formed as a computer, a telephone (whether cellular or otherwise), a radio device, a satellite device, or other communication device adapted to output at least one of an audio output and a graphic output (whether text, photo, video, or the like) and adapted to communicate with host 130 and/or one or more other user interface device. Host 130 is preferably formed as one or more server computer(s) and is operable to communicate with each of user interface devices 121-126 via one or more similar or analogous communication device(s). Accordingly, network 140 may be formed as a local or wide area network, such as the Internet, including one or more wired or wireless communication components, such as optical components, copper wire components, radio components, satellite components, and other communication network equipment. The selection and configuration of each of user interface devices 121-126, host 130, and network 140 is preferably limited only as required to enable some or all of the functionality described below.

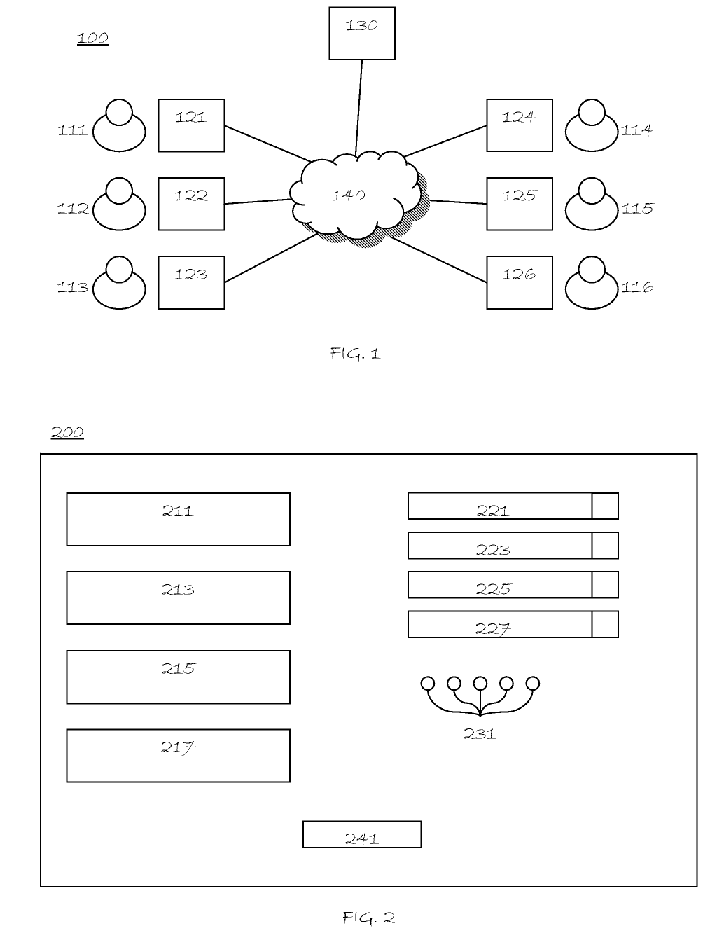

In an exemplary embodiment, host 130 may be accessed by a user, such as user 111, via a respective associated user interface device, such as user interface device 121. Upon accessing host 130, identification information, such as a username and password, may be required from user 111 for comparison with identification information of registered users. If user 111 has not yet registered, interface 200, depicted in FIG. 2, may be provided to user 111 via user interface device 121 in the form of a webpage, a client computer program, or the like. User 111 may create an account by providing required and/or requested information via one or more of data entry fields 211-217, drop-down menus 221-227, and radio buttons 231. Such required and/or requested information preferably includes a telephone number, email address, name, and physical address of user 111, and may further include a birth date, social security number, service provider names, password, PIN code, and service provider account numbers of user 111, or the like. After user 111 has completed providing required and/or requested information via manipulation of interface 200, user 111 may submit the information provided by activation of element 241, such as a button, or the like.

After receiving and processing such user-provided information, such as by creating an account and associating the information with the account, host 130 may verify some or all of the information. For example, host 130 may transmit an email to the email address provided by user 111 containing a link. Activation of the link by user 111 may cause host 130 to initiate a telephone call to a telephone number, IP address, or the like, provided by user 111 during the account creation process, or the like, including analog, digital, cellular, satellite, and land-line telephone calls or telephone calls placed over a computer network, whereby the phone number provided by user 111 may be verified. User 111 may then be required to enter verification information to verify that the phone number provided is associated with user 111, such as information contained in the email, such as in the form of a Captcha or other information not readable by a machine, or in the form of a PIN number or other user-provided information or code. Once the user's email address, phone number, and/or other information has been verified, the account associated with the user may be activated by host 130, whereafter user 111 may use system 100.

If user 111 is a registered user, then user 111 may access host 130 via user terminal 121 after verification of user-supplied identification information. Alternatively, if user 111 is not a registered user, but nonetheless wants to access system 100, user 111 may log on as a guest, wherein access to some but preferably not all features is permitted. In either case, user 111 may access a directory of system 100 via interface 300, as depicted in FIG. 3, such as a directory in the form of one or more database(s) stored on a storage medium of host 130. Maintenance of the directory on host 130 allows an operator of system 100 to ensure the veracity and accuracy of information contained therein, thereby enabling users to rely on such information. In use, user 111 may search for one or more service provider to facilitate selection of a service provided for needed services (including services associated with the sale or manufacture of goods, or the like). For example, user 111 may enter a keyword into entry box 311 of interface 300 and submit the keyword to host 130. Alternatively, or additionally, user 111 may select keywords or categories from drop-down menus 313. The keywords and/or categories may include descriptions of goods, descriptions of services, geographic limitations, price limitations, rating limitations, or other search criteria, as will be understood by those ordinarily skilled in the art. Thus, user 111 may search for a specific provider, one or more provider(s) meeting selected criteria, or may easily browse for a provider.

Regardless of how user 111 provides search criteria, host 130 may then provide a result, or a list of results, generated in response to the user-provided search criteria. A list of results may include names 321-329 of service providers, such as provider-users 114, 115, 116, respectively, among others, offering business services associated with the user-provided search criteria. Host 130 may further provide respective associated rating indications 330, such as an indication of an average rating provided by registered users of system 100, such as users 112, 113, among others, who are verified customers of the associated one of service providers 321-329. Furthermore, additional information associated with each of service providers 321-329 may be provided in fields 341-349, respectively. For example, an indication may be provided informing user 111 whether certain additional information is available for an associated one of service providers 321-329, such as an indication of whether system 100 includes one or more associated recorded interaction with a customer that is available for review, and/or whether other documentary evidence, such as recorded interactions between a respective one of service providers 321-329 (or between a former customer of a respective one of service providers 321-329) and another service provider, is available for review that may establish information about the respective one of service providers 321-329. More specifically, field 341 may include an indication that a recorded interaction between service provider 321 and user 112, a customer of service provider 321, is available for review, and/or that a recorded interaction between service provider 321, or a customer of service provider 321, and user 115, an insurance provider for service provider 321, is available to prove that service provider 321 maintains such insurance. As will be understood by those skilled in the art, many alternative facts, or the like, may be established via recorded interactions maintained by host 130 for use in promoting the business services of an associated service provider, including, but not limited to, licensure, qualification, endorsement, or the like.

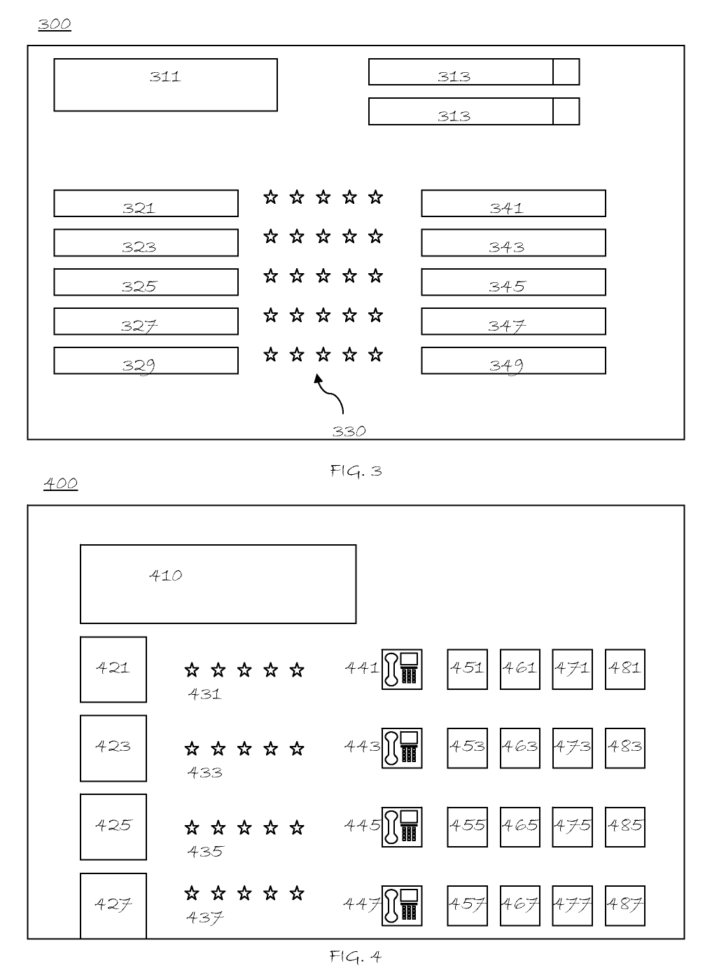

Thus, user 111 may review various information associated with one or more service provider, such as users 114-116, among others, for use in selecting a service provider with whom to do business. For additional information, user 111 may activate a link, or other means, to access additional and/or specific information pertaining to any of users 114-116, among others, associated with names 321-329 and/or fields 341-349. For example, activating a link associated with name 321 may cause interface 400, as depicted in FIG. 4, associated with user 114 to be provided to user 111. Interface 400 preferably includes an indication that interface 400 is associated with user 114, such as via information displayed in area 410. Additionally, interface 400 preferably includes posted recorded interactions 421-427 between user 114 and a respective registered user of system 100 who is a customer of user 114. User 111 may access and review one or more of selected recorded interactions 421-427 to obtain objective evidence of the quality of service provided to customers by user 124.

The user may then use such objective evidence to evaluate user-provided rating information provided by the respective registered user's of system 100 displayed as stars 431-437 as well as commentary or anecdotal evidence of the service level of user 124 provided by the respective user in fields 451, 461, 471, and 481. For example, if user 111 determines, through independent assessment, that the level of service of evidenced by the recorded interaction 421 is acceptable, user 111 may accordingly reduce a weight given to, or completely ignore, an associated low rating in stars 431 and/or negative commentary or anecdotal evaluations provided by the associated user in fields 451, 461, 471, and 481, or alternatively may increase a weight given to an associated high rating in stars 431 and/or positive commentary or anecdotal evaluations provided by the associated user in fields 451, 461, 471, and 481 in making a decision regarding selection of a service provider. Additional and/or alternative types of evaluations, commentary, assessment, or the like, may be included in fields 451-487, such as discussion board thread style responses or posts, with or without attachment or inclusion of additional objective and/or subjective evidence of service quality associated with user 114. Such additional and/or alternative information may be included in interface 400 and/or in additional interfaces, such as a discussion board interface, a blog-style interface, or the like.

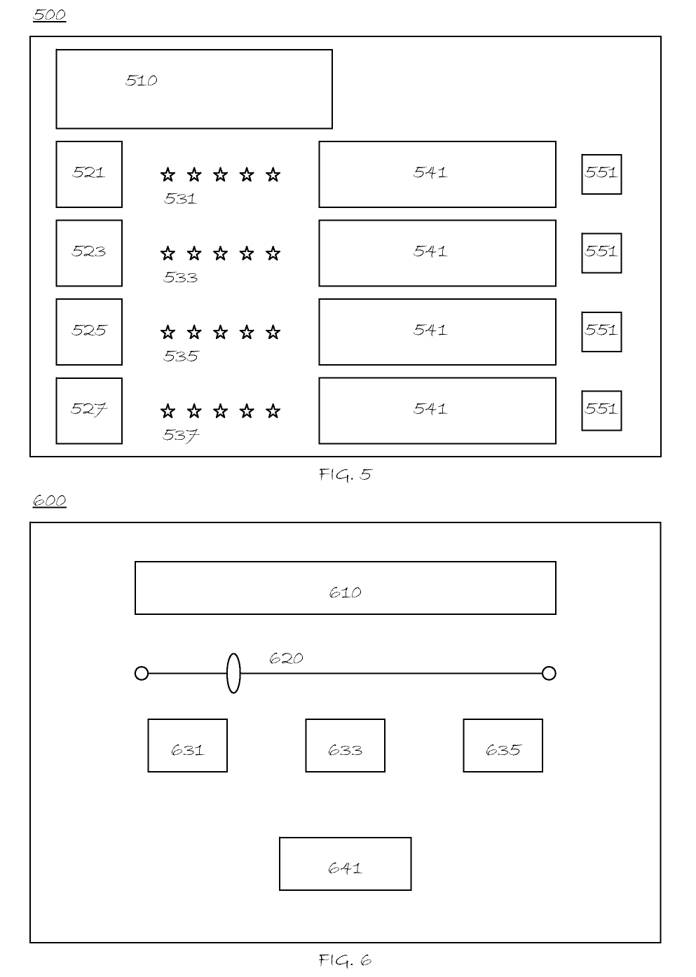

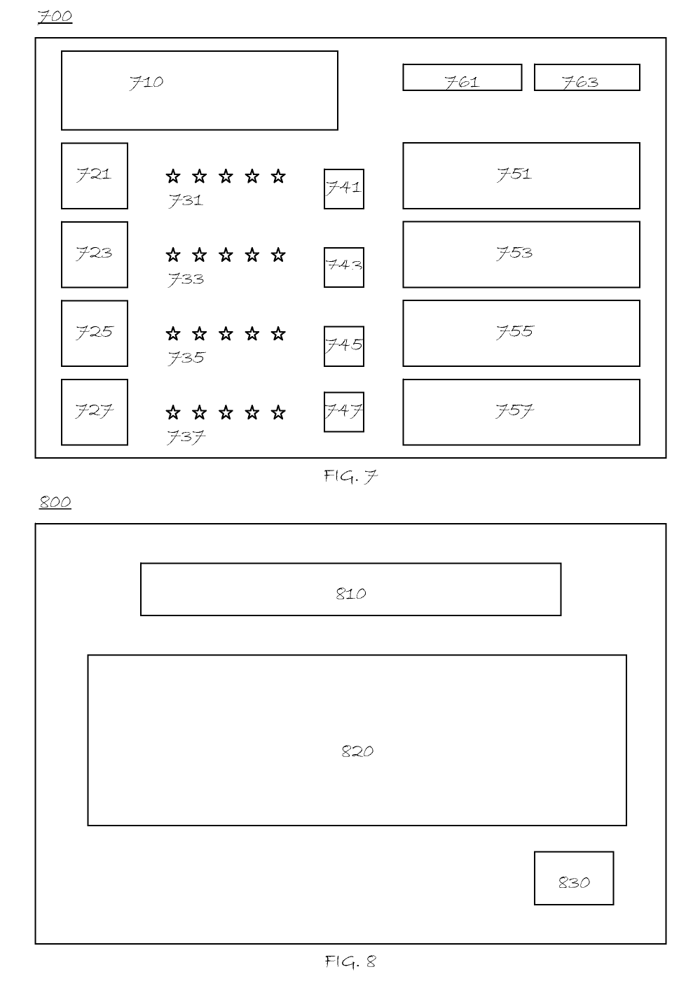

Interface 700, an exemplary additional interface depicted in FIG. 7, is preferably formed as a list of recorded service provider/customer interactions 721-727, such as a list sorted by most views, highest rating, most recent, geographic proximity, type of product/service, or the like. Additional subjective and/or objective evidence of customer service may be included in rating fields 731-737, link fields 741-747, and text fields 541-547, or the like. Preferably, the list is sorted by most views and has no filter applied, whereby recorded interaction 721 at the top of the list is the recorded interaction having the highest number of views by users regardless of the type of service, rating, geographical area, or the like. Alternatively, however, the list may be specific to one category or keyword, as desired, which may be entered or selected via search field 761 and/or filter field 763. Thus, users of system 100 may quickly and easily locate recorded interactions that have generated popular interest, such as for evidencing outstanding good or poor service, or the like, whereby service providers may be motivated to provide good service to all customers out of concern that a recorded interaction evidencing poor service may reach the top of the list, and by the goal of having a recorded interaction evidencing good service reach the top of the list. Accordingly, service providers associated with system 100 (which is preferably all service providers) may be motivated to do what they say at all times as a result of the positive or negative publicity provided by verified recorded interactions with customers and associated ratings, anecdotes, comments, and/or the like.

After evaluating one or more service provider via one or more of interfaces 300, 400, 700, and 800, user 111 may make a selection, and contact a service provider, such as user 114 via system 100. Specifically, a contact feature may be initiated via button 441 from interface 400, via field 341 from interface 300, or the like. The contact feature is preferably restricted to only registered users and preferably causes system 100 to automatically contact user 111, such as at a previously-provided phone number, IP address, or the like, and may require user 111 to enter a PIN number or other code or identification information, whereby the identity of user 111 is verified. System 100 then contacts user 114, such as via a conferencing feature, and begins a recording process performed by host 130 that captures the interaction between users 111 and 114. User 111 may interact with user 114, such as by asking questions, arranging for service, resolving disputes, or the like. When the interaction has ended, host 130 preferably automatically stores a copy of the interaction and associates the stored interaction with the account of user 111. Accordingly, user 114 may not have access to the copy of the recorded interaction, although it is contemplated that user 114 may also have permission to view the recorded interaction, but not edit or publish the recorded interaction, whereby user 114 may compare the unedited recorded interaction with an edited version subsequently published by user 111. In a preferred embodiment, the recorded interaction is, at least initially, not accessible to any users of system 100 except user 111, and except user 114 as mentioned above, thereby avoiding accidental or unwanted publication of private information captured during the interaction, such as personal identification information, financial information, or the like. Furthermore, such default privacy of the recorded interaction preferably prevents all recorded interactions from flooding system 100.

As shown in FIG. 5, user 111 may then access the recorded interaction via account management interface 500 including header 510, one or more recorded interactions with various service providers 521-527, and respective associated rating input fields 531-537, comment input fields 541-547, and publicity status fields 551-557. Specifically, user 111 may review and/or edit recorded interactions 521-527 via interface 600, discussed in greater detail below, such as by activating a link associated with a respective one of recorded interactions 521-527. User 111 may further assign a rating, such as by selecting a star associated with the selected rating in a respective one of rating input fields 531-537. Anecdotal evidence or other comments, including links to additional objective evidence recorded through system 100, may be added in a respective one of comment input fields 541-547 to supplement the rating and recorded interaction information for use by potential customers in evaluating the associated service provider, such as in the method described above. When user 111 is satisfied with the state of a recorded interaction, such as recorded interaction 521, and the additional rating and/or comments provided, user 111 may make recorded interaction 521 available to other users via manipulation of publicity status field 551.

As mentioned briefly above, and as shown in FIG. 6, interface 600 may be accessed by user 111 to edit a recorded interaction. Preferably, although not necessarily, system 100 limits the editing capability of user 111 to only redaction, whereby system 100 ensures that all recorded interactions stored on host 130 and accessible through system 100 accurately reflect the interaction, and are not biased, which bias may be introduced by addition of content to the recorded interaction. Specifically, interface 600 preferably includes header 610, playback bar 620 indicating a current position within a recorded interaction, and controls 631-641. Activation of control 631, such as in the form of a button, preferably starts a playback of an associated recorded interaction. Activation of control 633 preferably redacts the recorded interaction, such as by masking sensitive information via muting, adding a beep, adding a graphic, or the like, to allow selected content of the recorded interaction to remain private. For example, in an audio recording context, a beep may be used to mask the name, address, account number, financial information, or the like of user 111 or of user 114. Alternatively, the sound may simply be removed leaving dead space. In a video or text context, a black mark may be used to mask an image of user 111 or personal information displayed in text form, or the like. Such editing features preferably prevent substantive alteration or modification of the content or context of the recorded interaction, and a warning may optionally include a flag or other warning indicating that editing has been performed and that the content and/or context may have been altered as a result.

Control 635 may be activated to perform other selected editing functions allowed by system 100, as desired, such as cutting out unnecessary portions of the recorded interaction, such as hold periods, if desired and allowed by an operator of system 100, or the like. Activation of control 641 preferably saves a copy of the edited interaction. Such edited interaction may replace the recorded interaction, or may be stored in addition to the recorded interaction. Preferably, at least in specified circumstances, such as where portions of the recorded interaction were removed entirely, an unedited copy of the recorded interaction is maintained on host 130 for use in auditing the edited interaction to verify that the edited interaction is not biased. Thus the integrity of system 100 may be ensured.

Now referring to interface 800, users of system 100, such as service providers 114-116, may elect to use published interactions available through system 100 as advertising on a website or the like, whether or not maintained on host 130. Since recorded (and edited) interactions are stored on host 130, service provider 114, for example, may add feed 830 to a webpage or other publicity tool, in addition to information 810 and 820 controlled by user 114. Feed 830 is preferably not editable or controlled by user 114, and may only be turned “on” or turned “off” by user 114, such as through an account management feature of system 100. In a preferred embodiment, feed 830 preferably provides access to a predetermined number of recorded (or edited) interactions published by users of system 100, with or without additional rating and/or comment information. Host 130 preferably causes selected recorded (or edited) interactions to be displayed via feed 830. For example, host 130 may cause the most recent 5 edited interactions to be repeatedly displayed on interface 800 via feed 830. Alternatively, random edited interactions may be displayed via feed 830, and such interactions may be displayed only on demand, if desired. Preferably, however, interactions are only made available via feed 830, or via other means such as interfaces 300, 400, and/or 700, if an associated user has designated that such interaction may be publicized, such as via an associated publicity status field.

As a further alternative, feed 830 may be operable to cause one or more recorded feedback or comment to be published thereby. For example, user 111 may record feedback for user 114 in response to a request from user 114. In a specific example, user 114 may activate a feedback solicitation feature of system 100 after providing service to user 111, whereafter system 100 may solicit feedback from user 111, such as via a telephone call, a voice over IP call, an email including a link to initiate a call, or an email form for leaving feedback. In response to the solicitation from system 100, user 111 may record feedback for user 114, including in voice, text, video, or other format, which may be stored on host 130. Thus, feed 830 may provide access to such feedback recordings, either in addition to, or in place of, providing access to recorded interactions between a service provider and a customer.

According to an exemplary method of use, user 111 may access system 100 via a website. User 111 may then log in to host 130 by providing a user name and password combination. After verification of the user name and password combination by host 130, user 111 may then search for a provider of a selected good or service. If user 111 desires to locate a mechanic to repair his car, user 111 may input a keyword, such as “auto mechanic” in an entry box. User 111 may additionally, or alternatively, select a geographic proximity limitation and a rating limitation from drop-down menus. User 111 may then submit the keyword and/or other search criteria to host 130 for processing. After host 130 receives such submitted criteria, host 130 then preferably searches one or more database, or the like, to locate all service providers who meet or match the submitted criteria. Host 130 then preferably displays the names of the located service providers who meet or match the submitted criteria in a list of names, which may be sorted according to relevance, or the like, and which may be resorted according to a preference of user 111. User 111 may then review rating indications and information fields containing objective and/or subjective information. Specifically, an information field associated with one of the service providers may include one or more link by which a recorded interaction may be reviewed and commentary from users of system 100.

If user 111 desires to contact one of the providers listed, user 111 may activate a contact feature of system 100. If, instead, user 111 wants to investigate a selected provider further, user 111 may access a webpage associated with the selected provider. The website associated with the selected provider preferably includes a plurality of links providing access to respective recorded interactions between the selected service provider and users of system 100. User 111 may review one or more of the recorded interactions in addition to one or more rating and/or comment associated with each recorded interaction. User 111 may use the recorded interactions to assess associated ratings and/or comments, in evaluating the selected service provider. If user 111 desires, based on such an evaluation, to contact the selected provider, user 111 may then activate the contact feature. Alternatively, user 111 may investigate other service providers from the list via respective associated web pages, and may contact a selected one of the other providers via the contact feature.

In another exemplary method of use, user 114 may be interacting with a prospective customer. Such interaction may occur outside system 100, such as in person, and the prospective customer may or may not be a user of system 100. In an effort to convince user 111 to purchase goods or services from user 114, user 114 may access system 100 and access one or more recorded interaction, such as one or more recorded interaction between user 114 and other users of system 100 and/or recorded feedback from customers of user 114. For example, user 114 may access host 130 via a cellular telephone. User 114 may enter identification information and navigate a command menu, or the like, in order to initiate a playback of one or more recorded interaction, optionally including subjective information associated therewith, such as a rating and/or comment provided via system 100 by a customer of user 114. Alternatively, user 114 may access a website of user 114. Via such website, user 114 may allow the prospective customer to review recorded interaction, including associated ratings and/or comments, between user 114 and other customers. Preferably, the recorded interactions, and associated subjective information, selected for publication are selected at random, or are the most recent interactions, whereby the prospective customer may rely on such recorded interactions and associated subjective information as representative of the type of service and customer satisfaction provided by user 114.

As will be understood by those ordinarily skilled in the art, the various elements, features, and/or steps described above, may be accomplished by alternative means without departing from the scope of the present invention. For example, while illustrative embodiments of the present invention including web pages have been described, it should be understood that alternative webpage design elements may additionally and/or alternatively be included to accomplish the recited functionality and methodology. Furthermore, text to speech, speech to text, speech recognition, and/or recordings may be employed, whereby system 100 may be accessed via telephone interface, using number tones or speech commands to navigate menu options, receive information, initiate contact, edit recorded interactions, or the like.

Similarly, while a method of publicizing business services utilizing the Internet has been described, the invention is not limited to such specific methodology; numerous additional and/or alternative method steps may be included to accomplish the functionality and features described.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A method for publicizing business services via a communication interface comprising the steps of:
recording an interaction between at least one of a service provider and a customer; and
publicizing a copy of the recorded interaction via the communication interface,
wherein a prospective customer may review the publicized copy of the recorded interaction via the communication interface for use in evaluating business services offered by the service provider.

2. The method of claim 1, wherein the step of recording comprises placing a telephone call to a verified telephone number of the customer, placing a telephone call to a verified telephone number of the service provider, connecting the customer and the service provider, and recording an interaction of the customer and the service provider.

3. The method of claim 2, further comprising the step of charging a user account for recording the telephone call, wherein the user account is a user account associated with the service provider if the service provider is a sponsoring service provider, and wherein the user account is a user account associated with a customer if the service provider is not a sponsoring provider.

4. The method of claim 1, further comprising the step of storing a copy of the recorded interaction.

5. The method of claim 4, further comprising the step of associating the stored copy of the recorded interaction with an account of at least one of the service provider and the customer.

6. The method of claim 4, further comprising the step of editing the stored copy of the recorded interaction, wherein the step of publicizing a copy of the recorded interaction comprises publicizing an edited copy of the recorded interaction.

7. The method of claim 6, wherein the step of editing comprises performing at least one authorized editing function, wherein the at least one authorized editing function is selected to prevent a user from biasing the edited copy of the recorded interaction.

8. The method of claim 4, wherein the step of storing a copy of the recorded interaction comprises storing a copy of the recorded interaction on a storage medium controlled by host of the communication interface.

9. The method of claim 4, further comprising the step of associating at least one of a rating, a comment, an anecdote, and an opinion with the stored copy of the recorded interaction, wherein said at least one of a rating, a comment, an anecdote, and an opinion is publicized with the copy of the recorded interaction.

10. The method of claim 1, further comprising the steps of providing a searchable directory of service providers and locating a service provider via the searchable directory.

11. The method of claim 1, wherein the step of publicizing the recorded interaction comprises playing the copy of the recorded interaction.

12. The method of claim 2, wherein at least one of the steps of placing a telephone call to the customer and placing a telephone call to the service provider comprises placing a telephone call via a computer network.

13. A system for publicizing business services comprising:
a host operable to record at least one interaction between at least one of a service provider and a customer of the service provider;
a storage medium controlled by the host operable to store at least one recorded interaction; and
a communication interface operable to publicize the at least one recorded interaction stored on the storage medium.
wherein the at least one recorded interaction stored on the storage medium is associated with an account of at least one of the service provider and the customer.

14. The system of claim 13, wherein the host is operable to call a customer at a verified telephone number associated with the customer, call a service provider at a verified number associated with the service provider, connect the customer and the service provider, and record an interaction between the customer and the service provider.

15. The system of claim 13, wherein the communication interface comprises a directory of service providers, and wherein at least one recorded interaction is accessible via the communication interface and is associated with a respective service provider of the directory.

16. The system of claim 13, wherein the host comprises at least one computer accessible via an interface device.

17. The system of claim 16, wherein the interface device is selected from the group consisting of a personal computer, a phone, and a portable device.

18. The system of claim 13, wherein the host is further operable to edit at least one recorded interaction stored on the storage medium.

19. The system of claim 13, further comprising a plurality of accounts, wherein each account is associated with a verified user.

20. The system of claim 19, wherein each of the plurality of accounts is selected from the group consisting of service provider accounts, customer accounts, and combination accounts, said service provider accounts being selected from the group consisting of sponsoring service provider accounts and non-sponsoring service provider accounts.
